(19) United States
(12) Patent Application Publication
(10) Pub. No.: US 2026/0121832 A1
(43) Pub. Date: Apr. 30, 2026

(54) SCRAMBLING OF PIXEL DATA FOR VIDEO ENCRYPTION

(71) Applicant: Intel Corporation, Santa Clara, CA (US)

(72) Inventors: Yue Guo, Folsom, CA (US); Lindong Wu, Shanghai (CN); Yaqin Xiang, Shanghai (CN); Sanish Sebastian, Folsom, CA (US); Venkat Gokulrangan, Portland, OR (US)

(73) Assignee: Intel Corporation, Santa Clara, CA (US)

(21) Appl. No.: 19/431,638

(22) Filed: Dec. 23, 2025

(51) Int. Cl. H04L 9/06

(52) U.S. Cl. CPC H04L 9/0618

(57) ABSTRACT

Systems, apparatus, articles of manufacture, and methods for protecting video data during transmission to a display are disclosed. A disclosed example system accesses pixel blocks and scrambles selected bits of pixel components of the pixel blocks before block-based encryption, such as AES ECB mode. In some examples, one or more least significant bits of alpha components are scrambled when the alpha component is inactive, or on color component(s) when the alpha component is active. Pixel data may be reformatted to increase color component bit depth and reduce alpha depth, creating a new format that allows scrambling without perceptible loss. The scrambled block may be encrypted by existing hardware accelerators to generate encrypted pixel data to be stored and/or processed for transmission to the display. The technique eliminates visible outlines caused by deterministic encryption while maintaining compatibility with current display devices.

### BACKGROUND

Block-based video encryption involves encrypting an original block of pixel data to generate an encrypted block of pixel data having a same block size (e.g., a same number of bits). Advanced Encryption Standard (AES) Electronic Code Book (ECB) mode encryption is an example of block-based video encryption. In some compute systems, AES ECB mode encryption is used to encrypt the video data to be sent from a compute device to a display device to prevent unauthorized access to the video data.

### BRIEF DESCRIPTION OF THE DRAWINGS

FIG. 1 is a block diagram of an example compute system including an example compute device structured to scramble pixel data for video encryption in accordance with teaching of this disclosure.

FIG. 2 illustrates first example ciphering operations performed by the example compute system of FIG. 1.

FIG. 3 illustrates a first example pixel data processing flow implemented by the example system of FIG. 1 based on the first example ciphering operations of FIG. 2.

FIG. 4 illustrates second example ciphering operations performed by the example system of FIG. 1.

FIG. 5 illustrates a second example pixel data processing flow implemented by the example system of FIG. 1 to generate the second example ciphering operations of FIG. 4.

FIG. 6 illustrates example pixel data encryption results obtained with and without pixel data scrambling as disclosed herein.

FIG. 7 illustrates a third example pixel data processing flow implemented by the example compute device of FIG. 1 to generate third example encrypted pixel data.

FIG. 8 is a block diagram of an example implementation of example pixel data scrambler circuitry included in the example system of FIG. 1.

FIGS. 9-10 are flowcharts representative of example machine-readable instructions and/or example operations that may be executed, instantiated, and/or performed by example programmable circuitry to implement the example compute device of FIG. 1 and/or the example pixel data scrambler circuitry of FIGS. 1 and/or 3.

FIG. 11 is a block diagram of an example processing platform including programmable circuitry structured to execute, instantiate, and/or perform the example machine-readable instructions and/or perform the example operations of FIGS. 8-9 to implement the compute device of FIGS. 1-8.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 8-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Block-based video encryption, such as AES ECB mode encryption, can be used to encrypt video data to be sent from a compute device to a display device to prevent unauthorized access to the video data (e.g., while the data is stored in the compute device). However, such block-based video encryption may exhibit reproducible results in which the same input data yields the same encrypted output data. For example, depending on the block size being encrypted, pixel blocks associated with edges of an image/video frame may yield the same or similar encrypted output data, resulting in outlines of objects in the frame being visible in the encrypted state by an interceptor. Such outlines may unintentionally leak confidential and/or other important information intended to be protected by the block-based video encryption algorithm (e.g., AES ECB mode encryption).

Compute systems, such as personal computers, notebook computers, etc., may utilize hardware accelerators embedded in a compute device (e.g., central processing unit (CPU), graphics processing unit (GPU), system board (e.g., motherboard), etc.) of the system to block-encrypt original video data to generate encrypted video data to be stored on the compute device and/or to be sent to a display device (e.g., monitor, touchscreen, etc.) for display. Modifying the encryption algorithm implemented by such hardware accelerators to address the potential limitations of block-based encryption may be costly (e.g., due to the cost of replacing the hardware accelerator(s) in the compute device) and/or may result in a lack of compatibility with existing display devices (e.g., because the modified encryption algorithm implemented by such a modified hardware accelerator is incompatible with the decryption algorithm implemented by the existing display device).

Examples disclosed herein provide technical solutions to the foregoing technical problems associated with block-based video encryption by modifying the original pixel data prior to block-based encryption to reduce or eliminate the reproducibility characteristics of the encrypted pixel data, thereby reducing or eliminating the visible object outlines in the encrypted pixel data. Because the pixel data modification is performed prior to encryption, at least some examples disclosed herein can be used with existing hardware accelerators that implement block-based encryption (e.g., existing AES ECB hardware accelerators). As such, at least some examples disclosed herein may be compatible with existing display devices and compute devices. Furthermore, in at least some examples disclosed herein, the modifications made to the original pixel data prior to block-based encryption cause little to no degradation in the quality of the resulting video frames displayed by the display device.

Some examples disclosed herein modify an original block of pixel data, which is to be encrypted by a block-based video encryption (e.g., AES ECB mode encryption) by scrambling, flipping and/or otherwise modifying one or more bits of one or more components of one or more pixels in the original pixel block to generate a modified block of pixel data, also referred to herein as a scrambled block of pixel data. In some examples, the one or more bits of the one or one or more components of the one or more pixels are scrambled, flipped and/or otherwise modified based on a random or pseudo-random number generation algorithm. (As used herein, bit scrambling includes bit flipping and/or any other bit modification technique unless stated otherwise.) For example, pixels of a pixel block to be encrypted may include three (3) color components, such as red (R), green (G) and blue (B) color components, or luminance (Y) and chrominance (UV) components, and one alpha (A) component, which specifies the transparency or opacity or the given pixel. In some examples, one or more bits of the alpha component(s) and/or one or more bits of one or more of the color components of one or more pixels of the original block of pixel data are scrambled to generate a scrambled block of pixel data that undergoes block-based video encryption (e.g., AES ECB mode encryption) prior to being sent to a display device.

For example, if the alpha component of the pixel data is inactive (e.g., unused) in a particular video application executing on the compute device, examples disclosed herein may scramble one or more bits (e.g., one or more least significant bits) of the alpha component(s) of the pixel(s) of the original block of pixel data to generate the scrambled block of pixel data to be encrypted. In such examples, the display device ignores (e.g., discards) the alpha components of the pixel data when displaying a video frame and, thus, scrambling one or more bits of the alpha component(s) results in no degradation of video quality. In some examples disclosed herein, if the alpha component of the pixel data is active (e.g., used) in a particular video application executing on the compute device, examples disclosed herein may scramble one or more bits of one or more of the color component(s) of the pixel(s) of the original block of pixel data to generate the scrambled block of pixel data to be encrypted. For example, one or more least significant bits (LSBs) of one or more of the color component(s) of the pixel(s) of the original block of pixel data may be scrambled to mitigate (e.g., reduce or eliminate) the impact of the scrambling on the resulting video frames displayed by the display device. Some examples disclosed herein may reformat the pixel data to increase a size (e.g., bit length, bit resolution, number of bits, etc.) of the color components of the pixel data prior to scrambling to further mitigate (e.g., reduce or eliminate) the impact of the scrambling on the resulting video frames displayed by the display device.

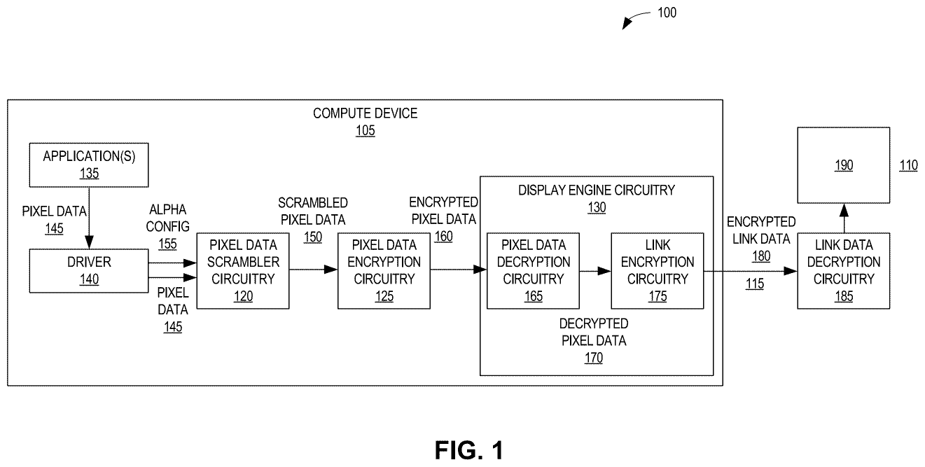

FIG. 1 is a block diagram of an example compute system 100 in which an example compute device 105 operates to scramble pixel data for video encryption in accordance with teaching of this disclosure. The compute system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the compute system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example system 100 of FIG. 1 may be any type of compute system capable of generating and displaying image and/or video data. For example, the compute system 100 may be a personal computer, a notebook computer, a server, a smartphone, a media device, etc. The compute system 100 includes the example compute device 105 and an example display device 110. The compute device 105 of the illustrated example can be any type of compute device capable of generating or otherwise providing image and/or video data to be displayed. For example, the compute device 105 may be a CPU, a GPU, a system board (e.g., a motherboard), a personal computer, a notebook computer, a server, a smartphone, a media device, etc. The display device 110 of the illustrated example may be any type of display device capable of displaying image and/or video data. For example, the display device 110 may be a computer monitor, a television, a touchscreen display, etc. In some examples, the compute device 105 and the display device 110 are separate devices (e.g., with separate housings, chassis, etc.). In some examples, the compute device 105 and the display device 110 are integrated into the compute system 100 (e.g., included in a same housing, chassis, etc.).

In the illustrated example system 100 of FIG. 1, the compute device 105 generates pixel data corresponding to an image or video frame to be displayed by the display device 110, and sends the pixel data to the display device 110 via an example interface 115. The interface 115 of the illustrated example can be any type of interface capable of sending (e.g., transmitting) pixel data from the compute device 105 to the display device 110. For example, the interface 115 may be High-Definition Multimedia Interface (HDMI), DisplayPort (DP), Digital Visual Interface (DVI), Video Graphics Array (VGA), Universal Serial Bus (USB), etc., and/or any other wired and/or wireless interface, and/or combination thereof.

The compute device 105 of the illustrated example includes example pixel data scrambler circuitry 120, example pixel data encryption circuitry 125 and example display engine circuitry 130. The compute device 105 of the illustrated example includes and/or executes one or more example application(s) 135 and an example driver 140, The application(s) 135 include any application capable of generating or otherwise providing example pixel data 145 corresponding to image and/or video frames (collectively referred to as frames) for presentation by the display device 110. The pixel data 145 is also referred to herein as example original pixel data 145 as it corresponds to pixel data that has not been scrambled by the pixel data scrambler circuitry 120 or encrypted by the pixel data encryption circuitry 125.

In the illustrated example, the original pixel data 145 is packed into ARGB format such that each pixel of the frame includes three (3) color components corresponding to R, G and B color components, and one (1) alpha (A) component. However, in some examples, the original pixel data 145 can be packed into other formats, such as a format with three (3) color components corresponding to Y, U and V color components. and one (1) alpha (A) component, or a format with just (3) color components (e.g., RGB or YUV) and no alpha (A) component, etc. In some examples, the original pixel data 145 is formatted to have a size (e.g., bit length, bit resolution, number of bits, etc.) of eight (8) bits such that each component of a pixel is represented by an 8-bit value, such as an 8-bit alpha (A) component value, an 8-bit red (R) component value, an 8-bit green (G) component value and an 8-bit blue (B) component value, resulting in the ARGB value of the pixel being represented by 4×8=32 bits. In some examples, the original pixel data 145 is formatted to have a size in which the different components of a given pixel are represented by more or fewer bits, and with some or all of different components having the same or different numbers of bits.

The pixel data scrambler circuitry 120 of the illustrated example scrambles the original pixel data 145 from the application(s) 135 to generate example scrambled pixel data 150 to be encrypted by the pixel data encryption circuitry 125. In examples in which the pixel data encryption circuitry 125 implements block-encryption (e.g., AES ECB mode encryption), the pixel data scrambler circuitry 120 operates on blocks of the original pixels data 145, also referred to herein as original blocks of pixel data 145, to generate corresponding blocks of scrambled pixel data 150, also referred to herein as scrambled blocks of pixel data 150, to be input to the pixel data encryption circuitry 125 for block-encryption. In some examples, the pixel data scrambler circuitry 120 scrambles (e.g., changes, flips or otherwise modifies) one or more bits of one or more components of one or more pixels in the original block of pixel data 145 to generate a scrambled block of pixel data 150, also referred to herein as a modified block of pixel data 150. For example, the pixel data scrambler circuitry 120 may scramble one or more bits of the alpha component(s) and/or one or more bits of one or more of the color components of one or more pixels of the original block of pixel data to generate a corresponding scrambled block of pixel data 150 that undergoes block-based video encryption (e.g., AES ECB mode encryption) by the pixel data encryption circuitry 125 prior to being sent to a display device 110.

In some examples, the pixel data scrambler circuitry 120 can employ any randomization and/or pseudo-randomization algorithm to scramble (e.g., change, flip or otherwise modify) the one or more bits of the one or more components of the one or more pixels of the original block of pixel data 145 to generate its corresponding scrambled block of pixel data 150. For example, the pixel data scrambler circuitry 120 scrambles (e.g., changes, flips or otherwise modifies) the one or more bits of the one or more components of the one or more pixels based on a random number generation algorithm.

In some examples, the pixel data scrambler circuitry 120 selects or otherwise determines which pixel component(s) to scramble based on example alpha configuration data 155 that specifies whether the alpha component of a given frame is active or inactive. In the illustrated example, the driver 140, which provides the pixel data scrambler circuitry 120 with access to the original pixel data 145 (e.g., via copying the pixel data to the pixel data scrambler circuitry 120, providing the pixel data scrambler circuitry 120 with pointer(s) to the pixel data in memory, etc.), determines whether the alpha component for a given frame is active or inactive, and includes its active/inactive determination in the alpha configuration data 155 provided to the pixel data scrambler circuitry 120. In some examples, the original pixel data 145 from the application(s) 135 may be formatted with color components (e.g., RGB or YUV) and without an alpha component. In such examples, the driver 140 may implement any color conversion algorithm (or invokes one or more hardware and/or software processor elements implementing any color conversion algorithm(s)) to convert the original pixel data 145 to add an alpha component to the original pixel data 145 (e.g., by converting the original RGB pixel data to ARGB pixel data). In such examples, the driver 140 knows that the alpha component was not present in the original pixel data (e.g., RGB data) and, thus, is inactive in the converted original pixel data (e.g., converted ARGB data). Thus, in such examples, the driver 140 specifies, in the alpha configuration data 155, that the alpha component is inactive in the current frame being processed.

In some examples, the alpha component is present in the original pixel data 145 from the application(s) 135 but unused. For example, in some systems 100, the uncompressed raw images or videos for display are packed in ARGB format, but the application 135 does not blend the pixel data on a per-pixel basis and, thus, may use a global alpha value (e.g., conveyed in addition to and/or separately from the pixel data) instead of the per-pixel alpha components of the individual pixels in the frame. Windows® Desktop Window Manager (DWM) is an example of such an application 135. In some such examples, the application 135 sets the values of the alpha components of the pixels of a frame to a default value, such as 0xFF or 0hFF for 8-bit data or some other value, to indicate the alpha component is unused. In such examples, the driver 140 examines the values of the alpha components in an original block of pixels 145, determines the alpha component is inactive if the values correspond to the default value (e.g., 0xFF or 0hFF), and specifies the same in the alpha configuration data 155. Otherwise, the driver 140 may specify that the alpha component is active for the pixels of the current frame.

In some examples, if the alpha configuration data 155 indicates the alpha component of an original block of pixel data 145 is inactive (e.g., unused), the pixel data scrambler circuitry 120 scrambles one or more bits of the alpha component(s) of the pixel(s) of the original block of pixel data to generate the corresponding scrambled block of pixel data 150 to be encrypted by the pixel data encryption circuitry 125. For example, the pixel data scrambler circuitry 120 may scramble one or more of the least significant bits (LSBs) of the alpha component(s) of one or more pixels included in the original block of pixel data to generate the corresponding scrambled block of pixel data 150 to be encrypted by the pixel data encryption circuitry 125. However, if the alpha configuration data 155 indicates the alpha component of an original block of pixel data 145 is active (e.g., used), the pixel data scrambler circuitry 120 may scramble one or more bits of one or more of the color component(s) of the pixel(s) of the original block of pixel data 145 to generate the corresponding scrambled block of pixel data 150 to be encrypted. For example, the pixel data scrambler circuitry 120 may scramble one or more LSBs of the original block of pixel data 145 to generate the corresponding scrambled block of pixel data 150 to be encrypted. In some examples, the pixel data scrambler circuitry 120 reformats the original block of pixel data 145 to increase a size (e.g., bit length, bit resolution, number of bits, etc.) of the color components of the pixel data prior to scrambling to mitigate (e.g., reduce or eliminate) the impact of the scrambling on the resulting video frames displayed by the display device 110. Further details concerning the implementation and operation of the pixel data scrambler circuitry 120 are provided below.

The pixel data encryption circuitry 125 of the illustrated example encrypts the scrambled pixel data 150 to generate encrypted pixel data 160 to be stored on the compute device 105 and then provided to the display engine circuitry 130 for sending to the display device 110. In this way, the pixel data encryption circuitry 125 implements a secure path for providing the pixel data from the application(s) 170 to the display engine circuitry 130. In the illustrated example, the pixel data encryption circuitry 125 implements block-encryption, such as AES ECB mode encryption. As such, the pixel data encryption circuitry 125 encrypts a scrambled block of pixel data 150 to generate a corresponding encrypted block of pixel data 160 to provide to the display engine circuitry 130. However, in some examples, the pixel data encryption circuitry 125 can implement one or more encryption algorithms other than block-encryption to generate the encrypted pixel data 160 from the scrambled pixel data 150.

The display engine circuitry 130 of the illustrated example accesses the encrypted pixel data 160 output from the pixel data encryption circuitry 125. For example, the display engine circuitry 130 may read or otherwise access the encrypted pixel data 160 from secure storage of the compute device 105. The display engine circuitry 130 can be any type of display engine circuitry that provides any appropriate data processing, formatting, timing, handshaking, etc., to provide the encrypted pixel data 160 to the display device 110 via the interface 115.

In the illustrated example, the display engine circuitry 130 includes example pixel data decryption circuitry 165. The pixel data decryption circuitry 165 of the illustrated example decrypts the encrypted pixel data 160 from the pixel data encryption circuitry 125 to generate decrypted pixel data 170, which corresponds to the scrambled pixel data 150. In some examples, the pixel data decryption circuitry 165 implements block-decryption, such as AES ECB mode decryption, which is the inverse of the block-encryption, such as AES ECB mode encryption, implemented by the pixel data encryption circuitry 125. In such examples, the pixel data decryption circuitry 165 decrypts an encrypted block of pixel data 160 to generate a corresponding decrypted block of pixel data 170, which corresponds to a corresponding block of scrambled pixel data 150. However, in some examples, the pixel data decryption circuitry 165 can implement one or more decryption algorithms other than block-encryption, but which is(are) the inverse(s) of the encryption algorithm(s) implemented by the pixel data encryption circuitry 125, to recover the scrambled pixel data 150.

The display engine circuitry 130 of the illustrated example also includes example link encryption circuitry 175 to generate encrypted link data 180 to be sent to the display device 110 via the interface 115. The pixel data encryption circuitry 125 can implement any encryption algorithm or algorithms suitable for encrypting data to be transmitted via the interface 115 to the display device 110. For example, the link encryption circuitry 175 can implement a block-based encryption algorithm, such as AES ECB mode encryption, and/or any another other encryption algorithm or algorithms.

The example display device 110 of FIG. 1 includes example link decryption circuitry 185. The link decryption circuitry 185 of the illustrated example decrypts the encrypted link data 180 received from the compute device 105 via the interface 115 to generate example received pixel data 190 to be displayed by the display device 110. In the illustrated example, the link decryption circuitry 185 implements one or more decryption algorithms that is(are) the inverse(s) of the encryption algorithm(s) implemented by the link encryption circuitry 175 in the compute device 105. In some examples, the link decryption circuitry 185 decrypts an encrypted block of link data 180 to generate a corresponding received block of pixel data 190 be displayed by the display device 110.

FIG. 1 illustrates an example implementation of the compute system 100, but the pixel data scrambling as disclosed herein is not limited thereto. For example, the application(s) 135 and/or the driver 140 may implement the scrambling functionality of the pixel data scrambler circuitry 120 and/or the encryption functionality of the pixel data encryption circuitry 125 in software, firmware, hardware, or any combination thereof, and, thus, the compute device 105 may not include separate pixel data scrambler circuitry 120 and/or pixel data encryption circuitry 125 in such examples. Additionally or alternatively, in some examples, the display engine circuitry 130 may implement the encryption functionality of the pixel data encryption circuitry 125 and/or the decryption functionality of the pixel data decryption circuitry 165 and, thus, the compute device 105 may not include separate pixel data encryption circuitry 125 and/or separate pixel data decryption circuitry 165 in such examples.

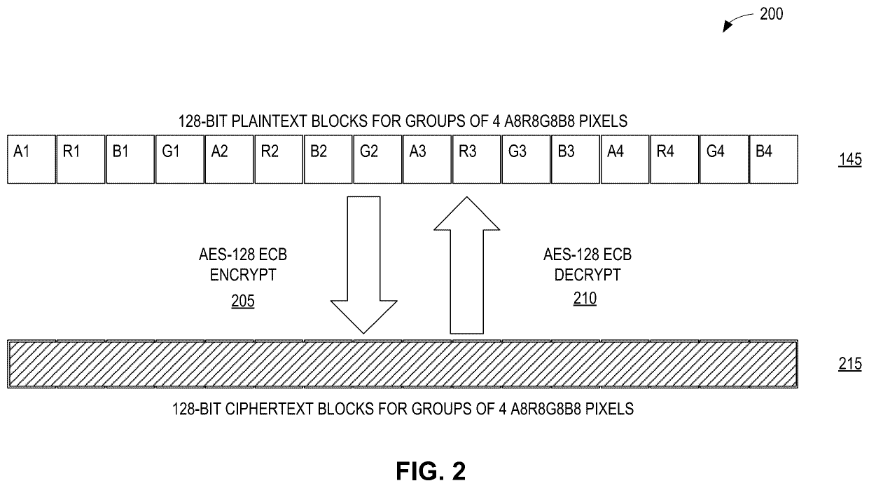

FIG. 2 illustrates first example ciphering operations 200 performed by the example compute system 100 of FIG. 1. In the illustrated example, the compute system 100 performs the first example ciphering operations 200 without scrambling the original pixel data 145 (e.g., with the pixel data scrambler circuitry 120 disabled, with the pixel data scrambling functionality in the driver 140 disabled, with the pixel data scrambling functionality in the application(s) 135 disabled, etc.). In the illustrated example of FIG. 2, the original pixel data 145 is formatted as 8-bit ARGB pixel data such that each of the A, R, G and B components of a pixel have 8 bits. As such, a given pixel of the original pixel data 145 is represented by 32 bits. Furthermore, the pixel data encryption circuitry 125 implements 128-bit AES ECB mode encryption and, thus, processes original blocks of pixel data 145 each including four (4) pixels in which the respective A, R, G and B components of corresponding ones of the pixels are concatenated into a 128-bit plaintext block of pixel data, as shown. Thus, in the first example ciphering operations 200 of FIG. 2, the pixel data encryption circuitry 125 performs an example 128-bit AES ECB mode encryption algorithm 205 on an original block of pixel data 145 containing 8-bit components of 4 pixels to generate a corresponding 128-bit encrypted block of pixel data 215. (In the illustrated example, the encrypted block of pixel data is labeled with reference numeral 215 because it is different than the encrypted block of pixel data 160 described above, the latter being generated based on a scrambled block of pixel data and not an original block of pixel data as in the first example ciphering operations 200 of FIG. 2) In the first example ciphering operations 200 of FIG. 2, the pixel data decryption circuitry 165 then performs an example 128-bit AES ECB mode decryption algorithm 210 on the 128-bit encrypted block of pixel data 215 to recover the original block of pixel data 145 to be displayed by the display device 110.

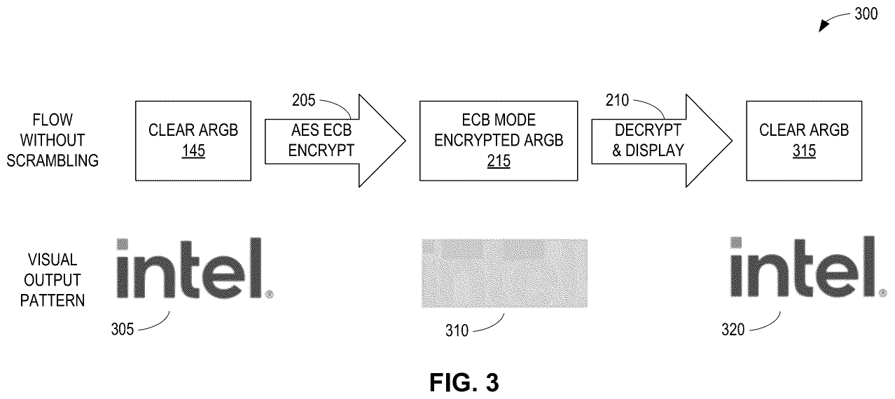

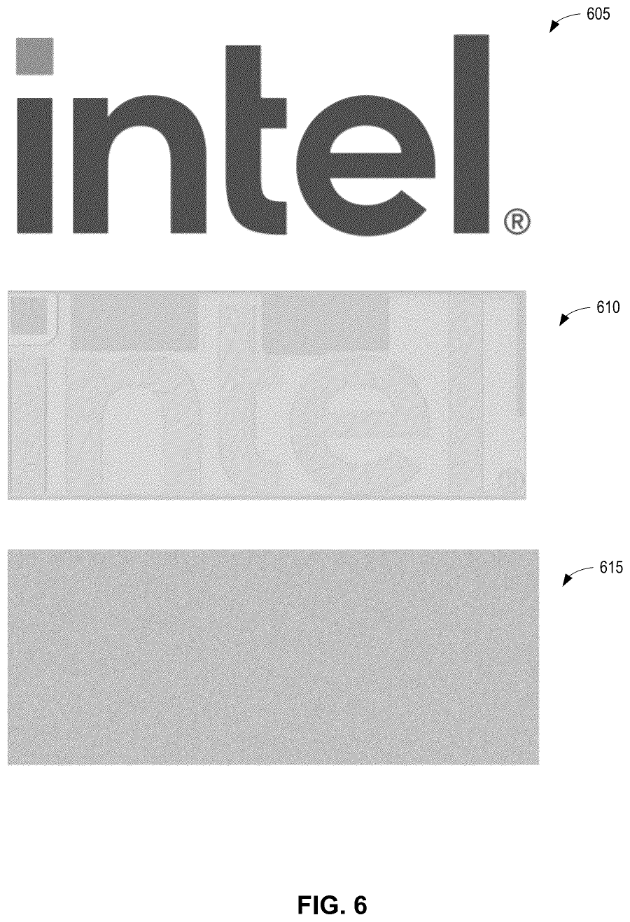

FIG. 3 illustrates a first example pixel data processing flow 300 implemented by the example system 100 of FIG. 1 based on the first example ciphering operations 200 of FIG. 2. As described above, the compute system 100 performs the first example ciphering operations 200 without scrambling the original pixel data 145 (e.g., with the pixel data scrambler circuitry 120 disabled, with the pixel data scrambling functionality in the driver 140 disabled, with the pixel data scrambling functionality in the application(s) 135 disabled, etc.). The first example pixel data processing flow 300 begins with example original pixel data 145 that depicts an example visual output pattern 305 of an example Intel® logo. In the first pixel data processing flow 300 of the illustrated example, the pixel data encryption circuitry 125 performs the example 128-bit AES ECB mode encryption algorithm 205 on the original blocks of pixel data 145 to generate the corresponding 128-bit encrypted blocks of pixel data 215. As shown in the example of FIG. 3, although encrypted, the encrypted blocks of pixel data 215 depicts an example visual output pattern 310 that contains an outline of the Intel® logo (due to the reproducibility characteristics of the AES ECB mode encryption described above), which demonstrates the potential for an unintended leak of protected information when scrambling is disabled. (This result is also shown in FIG. 6, which is described in detail below.) In the first pixel data processing flow 300 of the illustrated example, the pixel data decryption circuitry 165 then performs the example 128-bit AES ECB mode decryption algorithm 210 on the encrypted blocks of pixel data 160 to recover example decrypted blocks of pixel data 315 (e.g., which are different from the decrypted blocks of pixels 170 described above because scrambling is disabled), which correspond to the original blocks of pixel data 145 in the illustrated example (e.g., because scrambling is disabled). The decrypted blocks of pixel data 315 depict an example visual output pattern 320 corresponding to the example Intel® logo depicted by the original pixel data 145 (e.g., corresponding to the visual output pattern 305).

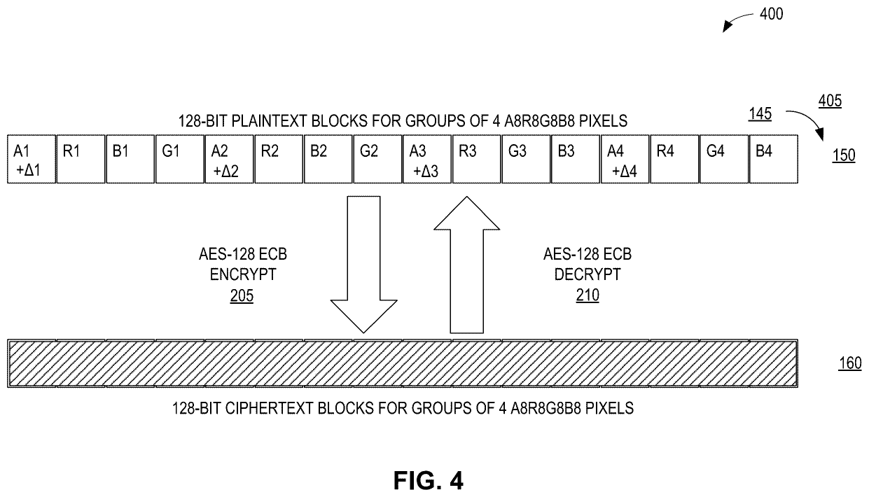

FIG. 4 illustrates second example ciphering operations 400 performed by the example compute system 100 of FIG. 1. In the illustrated example, the compute system 100 performs the second example ciphering operations 400 with scrambling of the original pixel data 145 (e.g., with the pixel data scrambler circuitry 120 enabled, with the pixel data scrambling functionality in the driver 140 enabled, with the pixel data scrambling functionality in the application(s) 135 enabled, etc.). As in the illustrated example of FIG. 2, in the illustrated example of FIG. 4, the original pixel data 145 is formatted as 8-bit ARGB pixel data such that each of the A, R, G and B components of a pixel have 8 bits. As such, a given pixel of the original pixel data 145 is represented by 32 bits. Furthermore, in the illustrated example of FIG. 4, the pixel data scrambler circuitry 120 is enabled and performs an example scrambling operation 405 to scramble one or more bits of the alpha (A) components of the four (4) pixels in the original block of pixel data 145 to generate the scrambled block of pixel data 150 (e.g., because the alpha component is determined to be inactive, as described above). The scrambling of the bit(s) of the alpha (A) components is represented in FIG. 4 as a delta change (+Δi) to the alpha component (Ai) of the i^{th} pixel. For example, the pixel data scrambler circuitry 120 may scramble the 2 LSBs of the alpha components (Ai) of the respective pixels of the original block of pixel data 145 to generate the scrambled block of pixel data 150, as described above. As shown in the illustrated example of FIG. 4, the scrambled block of pixel data 150 includes four (4) pixels in which the respective scrambled alpha component (A′), the red component (R), the green component (G) and the blue component (B) of the corresponding ones of the pixels are concatenated into a 128-bit scrambled block of pixel data

Continuing with the second example ciphering operations 400 of FIG. 4, similar to the first example ciphering operations 200 of FIG. 2, the pixel data encryption circuitry 125 implements 128-bit AES ECB mode encryption and, thus, processes scrambled blocks of pixel data 150, as shown. Thus, in the second example ciphering operations 400 of FIG. 4, the pixel data encryption circuitry 125 performs the example 128-bit AES ECB mode encryption algorithm 205 described above on the scrambled block of pixel data 150 containing 8-bit components of 4 pixels to generate a corresponding 128-bit encrypted block of pixel data 160, as described above. In the second example ciphering operations 400 of FIG. 4, the pixel data decryption circuitry 165 then performs an example 128-bit AES ECB mode decryption algorithm 210 on the 128-bit encrypted block of pixel data 160 to recover the scrambled block of pixel data 150, which is to be displayed by the display device 110.

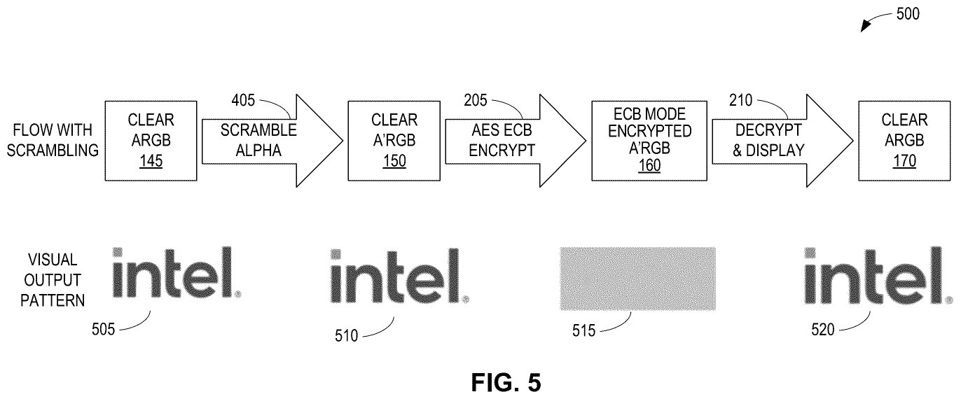

FIG. 5 illustrates a second example pixel data processing flow 500 implemented by the example system 100 of FIG. 1 based on the second example ciphering operations 400 of FIG. 4. As described above, the compute system 100 performs the second example ciphering operations 400 with scrambling of the original pixel data 145 (e.g., with the pixel data scrambler circuitry 120 enabled, with the pixel data scrambling functionality in the driver 140 enabled, with the pixel data scrambling functionality in the application(s) 135 enabled, etc.). The second example pixel data processing flow 500 begins with example original blocks of pixel data 145 that depict an example visual output pattern 505 of an example Intel® logo. In the second pixel data processing flow 500 of the illustrated example, the pixel data scrambler circuitry 120 performs the example scrambling operation 405 described above on the original blocks of pixel data 145 to generate the corresponding 128-bit scrambled blocks of pixel data 150. As shown in the example of FIG. 5, although scrambled, the scrambled blocks of pixel data 150 depicts an example visual output pattern 510 that is similar or identical to the visual output pattern 505 because the alpha component is unused or, if used, just the 2 LSBs of the alpha component have been scrambled.

In the second pixel data processing flow 500 of the illustrated example, the pixel data encryption circuitry 125 performs the example 128-bit AES ECB mode encryption algorithm 205 on the scrambled blocks of pixel data 150 to generate the corresponding 128-bit encrypted blocks of pixel data 160 described above. As shown in the example of FIG. 5, the encrypted blocks of pixel data 160 (e.g., with scrambling) depict an example visual output pattern 515 that is randomized and in which the Intel® logo is not viewable, thereby demonstrates the potential for scrambling to protect against unintended leak of protected information. (This result is also shown in FIG. 6, which is described in detail below.) In the second pixel data processing flow 500 of the illustrated example, the pixel data decryption circuitry 165 then performs the example 128-bit AES ECB mode decryption algorithm 210 on the encrypted blocks of pixel data 160 to recover example decrypted blocks of pixel data 170, which correspond to the scrambled blocks of pixel data 150 in the illustrated example (because scrambling is enabled in the illustrated example). The decrypted blocks of pixel data 170 of the illustrated example depict an example visual output pattern 520 corresponding to the example Intel® logo depicted by the scrambled blocks of pixel data 150 (e.g., corresponding to the visual output pattern 510), which is similar or identical to the example Intel® logo depicted by the original pixel data 145 (e.g., corresponding to the visual output pattern 505).

FIG. 6 illustrates example pixel data encryption results 600 obtained with and without pixel data scrambling as disclosed herein. FIG. 6 depicts an example visual output pattern 605 produced by the example original blocks of pixel data 145 described above and which are to be displayed by the display device 110. In the illustrated example and preceding examples, the original blocks of pixel data 145 produce an example Intel® logo in the visual output pattern 605. As such, the visual output pattern 605 corresponds to the visual output pattern 305 and the visual output pattern 505 illustrated in FIGS. 3 and 5, respectively.

FIG. 6 also depicts an example visual output pattern 610 produced by the encrypted blocks of pixel data 215, which are generated by the pixel data encryption circuitry 125 performing the 128-bit AES ECB mode encryption algorithm 205 on the original blocks of pixel data 145 without scrambling (e.g., with the pixel data scrambler circuitry 120 disabled, with the pixel data scrambling functionality in the driver 140 disabled, with the pixel data scrambling functionality in the application(s) 135 disabled, etc.). As such, the visual output pattern 610 produced by the encrypted blocks of pixel data 215 (without scrambling) corresponds to the visual output pattern 310 described above and depicts an outline of the Intel® logo (due to the reproducibility characteristics of the AES ECB mode encryption described above), which demonstrates the potential for an unintended leak of protected information when scrambling is disabled.

FIG. 6 further depicts an example visual output pattern 615 produced by the encrypted blocks of pixel data 160, which are generated by the pixel data encryption circuitry 125 performing the 128-bit AES ECB mode encryption algorithm 205 on the scrambled blocks of pixel data 150 (e.g., with the pixel data scrambler circuitry 120 enabled, with the pixel data scrambling functionality in the driver 140 enabled, with the pixel data scrambling functionality in the application(s) 135 enabled, etc., to scramble the original blocks of pixel data 145 to generate the scrambled blocks of pixel data 150). As such, the visual output pattern 615 produced by the encrypted blocks of pixel data 160 (with scrambling) corresponds to the visual output pattern 515 described above and depicts a randomized scene in which the outline of the Intel® logo is not viewable, which demonstrates the potential for scrambling to protect against unintended leak of protected information.

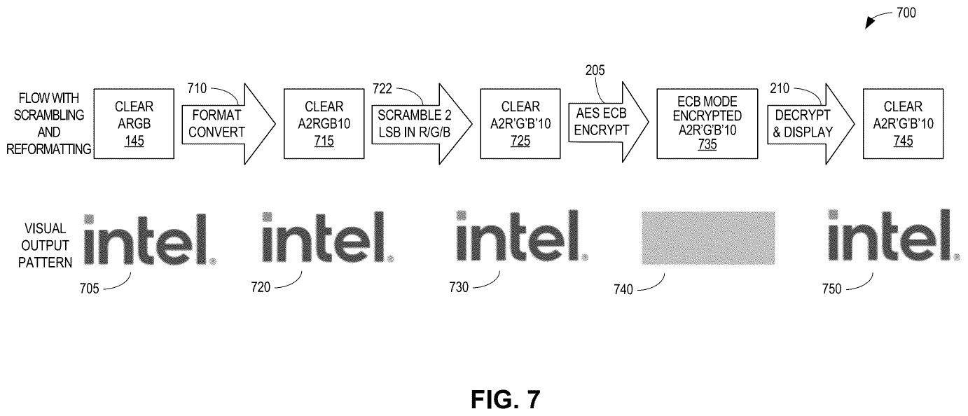

FIG. 7 illustrates a third example pixel data processing flow 700 implemented by the example system 100 of FIG. 1. The preceding example pixel data processing flows 300 and 500 assumed that the alpha (A) components of the original pixel data 145 were unused (e.g., inactive) and, thus, the pixel data scrambler circuitry 120 scrambled one or more bits of the alpha component(s) of the pixel(s) of the original blocks of pixel data 145 (e.g., such as the 2 LSBs). However, in some examples, the alpha (A) components of the original pixel data 145 may be active and used for per-pixel-alpha blending or composition. In some such examples, the pixel data scrambler circuitry 120 may scramble one or more bits of one or more of the color component(s) of the pixel(s) of the original block of pixel data 145 to generate the corresponding scrambled block of pixel data 150 to be encrypted. For example, the pixel data scrambler circuitry 120 may scramble one or more LSBs of one or more of the color component(s) of the original block of pixel data 145 to generate the corresponding scrambled block of pixel data 150 to be encrypted. In some examples, the pixel data scrambler circuitry 120 reformats the original block of pixel data 145 to increase a size (e.g., bit length, bit resolution, number of bits, etc.) of the color components of the pixel data prior to scrambling to mitigate (e.g., reduce or eliminate) the impact of the scrambling on the resulting video frames displayed by the display device 110. The third pixel data processing flow 700 illustrates an example of pixel data reformatting being used with pixel data scrambling.

The third example pixel data processing flow 700 begins with example original pixel data 145 that depicts an example visual output pattern 705 of an example Intel® logo. The original pixel data 145 is formatted with alpha, red, green and blue components each having 8 bits, which is denoted as ARGB8 pixel data or A8R8G8B8 pixel data.

In the third pixel data processing flow 700 of the illustrated example, the pixel data scrambler circuitry 120 reformats the original pixel data 145 to increase the sizes of the color components (e.g., the red, green and blue components). For example, the pixel data scrambler circuitry 120 may implement an example format conversion algorithm 710 to increase the sizes of the red, green and blue components to each have 10 bits and reduce the size of the alpha component to have 2 bits to generate example reformatted pixel data 715 which maintain the same overall number of bits (e.g., 32 bits) used to represent pixels as in the original pixel data 145. The reformatted pixel data 715 is denoted as A2RGB10 pixel data or A2R10G10B10 pixel data to indicate the R, G and B components have 10 bits and the A component has 2 bits. As shown in the example of FIG. 7, although reformatted, the reformatted pixel data 715 depicts an example visual output pattern 720 that is similar or identical to the visual output pattern 705 because color components of the pixel data still have the same resolution (e.g., with the 8 bits of the original components corresponding to the 8 most significant bits (MSBs) of the reformatted components, and the 2 LSBs of the 10 bit values not impacting the original 8-bit resolution of the pixel data). In the third pixel data processing flow 700 of the illustrated example, the display device 110 is assumed to support pixel data formatted as A2R10G10B10 data (e.g., which the color components have 10 bits each and the alpha components having 2 bits).

In the third pixel data processing flow 700 of the illustrated example, the pixel data scrambler circuitry 120 performs an example scrambling operation 722 on the reformatted blocks of pixel data 715 in which the 2 LSBs of each of the red (R), green (G) and blue (B) components of the pixels in the reformatted blocks of pixel data 715 are scrambled to generate corresponding 128-bit example scrambled blocks of pixel data 725. The scrambled pixel data 725 is denoted as A2R′G′B′10 pixel data or A2R′10G′10B′10 pixel data to indicate the R, G and B components have been scrambled and the A component is unchanged. As shown in the example of FIG. 7, although scrambled, the scrambled blocks of pixel data 725 depicts an example visual output pattern 730 that is similar or identical to the visual output pattern 705 because the 2 LSBs of the red (R), green (G) and blue (B) components are below the resolution of the original pixel data 145 and, thus, correspond to unnoticeable noise.

In the third pixel data processing flow 700 of the illustrated example, the pixel data encryption circuitry 125 performs the example 128-bit AES ECB mode encryption algorithm 205 on the scrambled blocks of pixel data 725 to generate corresponding 128-bit example encrypted blocks of pixel data 735. As shown in the example of FIG. 7, the encrypted blocks of pixel data 735 (e.g., with scrambling) depict an example visual output pattern 740 that is randomized and in which the Intel® logo is not viewable, thereby demonstrates the potential for scrambling to protect against unintended leak of protected information.

In the illustrated example, the pixel data decryption circuitry 165 performs the example 128-bit AES ECB mode decryption algorithm 210 on the encrypted blocks of pixel data 735 to recover example decrypted blocks of pixel data 745, which correspond to the scrambled blocks of pixel data 725 in the illustrated example (because scrambling is enabled in the illustrated example). The decrypted blocks of pixel data 745 of the illustrated example depict an example visual output pattern 750 corresponding to the example Intel® logo depicted by the scrambled blocks of pixel data 725 (e.g., corresponding to the visual output pattern 730), which is similar or identical to the example Intel® logo depicted by the original pixel data 145 (e.g., corresponding to the visual output pattern 705).

In some examples, such as in examples in which fine alpha granularity is utilized for per-pixel-alpha blending or composition, the original 8-bit resolution of the alpha component may be kept by reformatting the alpha and color components of the pixel data to increase the sizes of the alpha and color components of the pixel data such that one or more unused LSBs of the reformatted pixel data can be scrambled. For example, if supported by the display device 110, the pixel data processing flow 700 may be modified such that the pixel data scrambler circuitry 120 implements an example format conversion algorithm that increase the sizes of the alpha, red, green and blue components of the pixel data to each have 16 bits, resulting in pixels of the reformatted pixel data being represented by 64 bits. Such reformatted pixel data 715 is denoted as ARGB16 pixel data or A16R16G16B16 pixel data to indicate the A, R, G and B components have 16 bits. Such a change may increase memory traffic and bandwidth but maintain pixel component resolution requirements. In some examples, the rest of the pixel data processing flow 700 can remain unchanged by causing (e.g., configuring) the pixel data scrambler circuitry 120, the pixel data encryption circuitry 125 and the pixel data decryption circuitry 165 to scramble, encrypt and decrypt, respectively, pixel blocks containing two (2) pixels to maintain the ability to use the 128-bit processing algorithms described above.

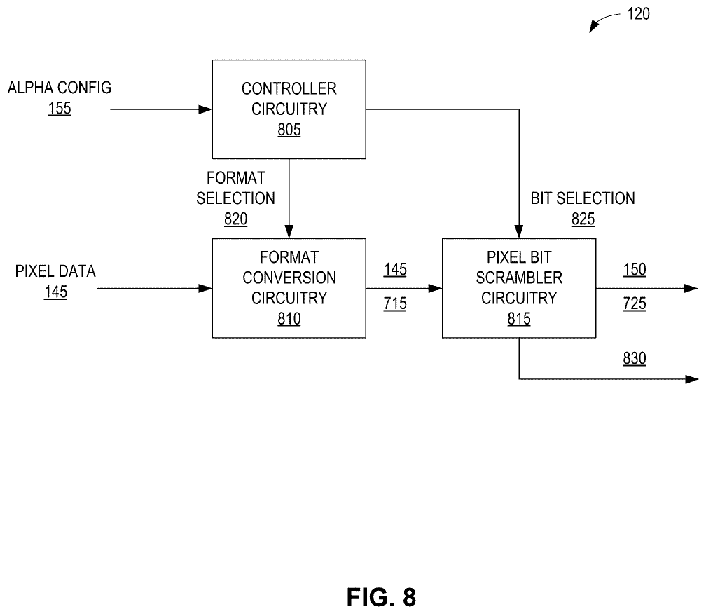

FIG. 8 is a block diagram of an example implementation of example pixel data scrambler circuitry 120 included in the example compute device 105 of the example system 100 of FIG. 1. The pixel data scrambler circuitry 120 of FIG. 8 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the pixel data scrambler circuitry 120 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

The example pixel data scrambler circuitry 120 of FIG. 8 includes example controller circuitry 805, example format conversion circuitry 810 and example pixel bit scrambler circuitry 815. The pixel bit scrambler circuitry 815 of the illustrated example scrambles one or more bits of one or more components of one or pixels of blocks of pixel data, as described above. The format conversion circuitry 810 of the illustrated example reformats one or more components of one or pixels of the blocks of pixel data, as described above. The controller circuitry 805 of the illustrated example controls operation of the pixel bit scrambler circuitry 815 and the format conversion circuitry 810.

For example, the controller circuitry 805 accepts as input the alpha configuration data 155 from the driver 140. As described above, the alpha configuration data 155 specifies whether the alpha component of a given frame of original pixel data 145 is active or inactive. As described above, the driver 140 may determine whether the alpha component is active or inactive based on initial configuration information (e.g., based on user input, application configuration data, etc.), based on whether an alpha component is included in the original pixel data, based on evaluation of the values of the alpha component of pixels of the frame data, etc. However, in some examples, the controller circuitry 805 determines the alpha configuration data 155 specifying whether the alpha component is active or inactive itself based on initial configuration information (e.g., based on user input, application configuration data, etc.), based on whether an alpha component is included in the original pixel data, based on evaluation of the values of the alpha component of pixels of the frame data, etc., as described above.

In some examples, the alpha configuration data 155 also specifies the number of bits of resolution of the alpha component if the alpha component is active. For example, the driver 140 may determine the bits of resolution of the alpha component based on initial configuration information (e.g., based on user input, application configuration data, etc.), and/or based on evaluation of the values of the alpha component of pixels of the frame data (e.g., to identify which bits vary among the alpha components of the different pixels of the frame), etc. However, in some examples, the controller circuitry 805 determines the alpha configuration data 155 specifying the bits of resolution of the alpha component based on initial configuration information (e.g., based on user input, application configuration data, etc.), and/or based on evaluation of the values of the alpha component of pixels of the frame data (e.g., to identify which bits vary among the alpha components of the different pixels of the frame), etc., as described above.

The controller circuitry 805 of the illustrated example outputs example format selection data 820 to the format conversion circuitry 810. In some examples, the format selection data 820 may specify the input format of the original pixel data 145 input to the format conversion circuitry 810 and the output format of the output pixel data from the format conversion circuitry 810. For example, the controller circuitry 805 may determine format selection data 820 to specify that the output pixel data from the format conversion circuitry 810 is to be the same as the input format of the original pixel data 145 based on a determination that the alpha component of the original pixel data 145 is inactive. In such an example, the format conversion circuitry 810 may disable reformatting and pass through the original pixel data 145 to the output of the format conversion circuitry 810. For example, the format selection data 820 may specify the input format of the original pixel data 145 is A8R8B8G8 and the format conversion circuitry 810 may pass the original pixel data 145 to its output with the same A8R8B8G8 format.

However, the controller circuitry 805 may determine that the output pixel data from the format conversion circuitry 810 is to be reformatted relative to the input format of the original pixel data 145 based on a determination that the alpha component of the original pixel data 145 is active. Furthermore, the controller circuitry 805 may determine the output format of the reformatted pixel data based on a determination of the bit resolution of the alpha component of the original pixel data 145. For example, if the input format of the original pixel data 145 is A8R8B8G8 and the controller circuitry 805 determines the alpha component is active and has 2-bit resolution, the controller circuitry 805 may determine the format selection data 820 to specify the output format is to be A2R10B10G10 such that the alpha component has 2-bit resolution and the color components each have 10-bit resolution. In such an example, the format conversion circuitry 810 may enable reformatting and reformat the original A8R8B8G8 pixel data 145 to generate the reformatted A2R10B10G10 pixel data 715 at the output of the format conversion circuitry 810, as described above. As another example, if the input format of the original pixel data 145 is A8R8B8G8 and the controller circuitry 805 determines the alpha component is active and has full 8-bit resolution, the controller circuitry 805 may determine the format selection data 820 to specify the output format is to be A16R16B16G16 such that the alpha component and the color components each have 16-bit resolution. In such an example, the format conversion circuitry 810 may enable reformatting and reformat the original A8R8B8G8 pixel data 145 to generate the reformatted A16R106B16G16 pixel data at the output of the format conversion circuitry 810, as described above.

The controller circuitry 805 of the illustrated example also outputs example bit selection data 825 to the pixel bit scrambler circuitry 815. In the illustrated example, the bit selection data specifies which one or more bits of which one or more components of which one or more pixels of the pixel blocks input to the pixel bit scrambler circuitry 815 are to be scrambled to generate output scrambled pixel data for encryption. For example, the controller circuitry 805 may determine the bit selection data 825 to specify that the pixel bit scrambler circuitry 815 is to scramble one or more LSBs (e.g., such as 2 LSBs) of the alpha components of the pixels in the pixel blocks input to the pixel bit scrambler circuitry 815 (e.g., the original A8R8B8G8 pixel data 145) based on a determination that the alpha component is inactive (e.g., unused) (e.g., corresponding to the A8R8B8G8 scrambled data 150). As another example, the controller circuitry 805 may determine the bit selection data 825 to specify that the pixel bit scrambler circuitry 815 is to scramble one or more LSBs (e.g., such as 2 LSBs) of the color components (e.g., R, G and/or B) of the pixels in the pixel blocks input to the pixel bit scrambler circuitry 815 (e.g., the reformatted A2R10B10G10 pixel data 715) based on a determination that the alpha component is active and has 2-bit resolution. As yet a further examples, the controller circuitry 805 may determine the bit selection data 825 to specify that the pixel bit scrambler circuitry 815 is to scramble one or more LSBs (e.g., such as 2 LSBs) of the alpha component and/or one or more of the color components (e.g., R, G and/or B) of the pixels in the pixel blocks input to the pixel bit scrambler circuitry 815 (e.g., the reformatted A16R16B16G16 pixel data) based on a determination that the alpha component is active and has full 8-bit resolution.

In some examples, the pixel bit scrambler circuitry 815 includes an example output 830 to provide a sequence of original (e.g., unscrambled) values of the pixel bits (e.g., LSBs) that were scrambled by pixel bit scrambler circuitry 815. For example, the sequence of original (e.g., unscrambled) values of the pixel bits (e.g., LSBs) can be sent to the display device 110 (e.g., separately from the encrypted pixel data output from the pixel data encryption circuitry 125) to permit the display device 110 to reconstruct the pixel bits that were scrambled by the pixel bit scrambler circuitry 815.

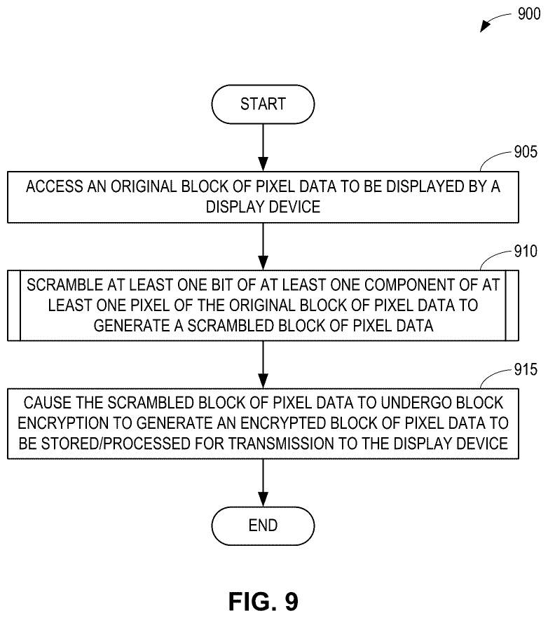

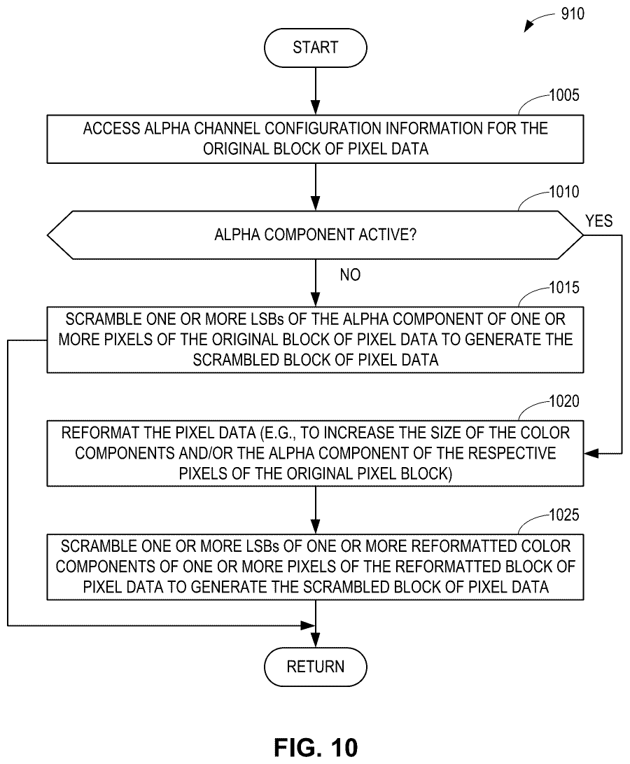

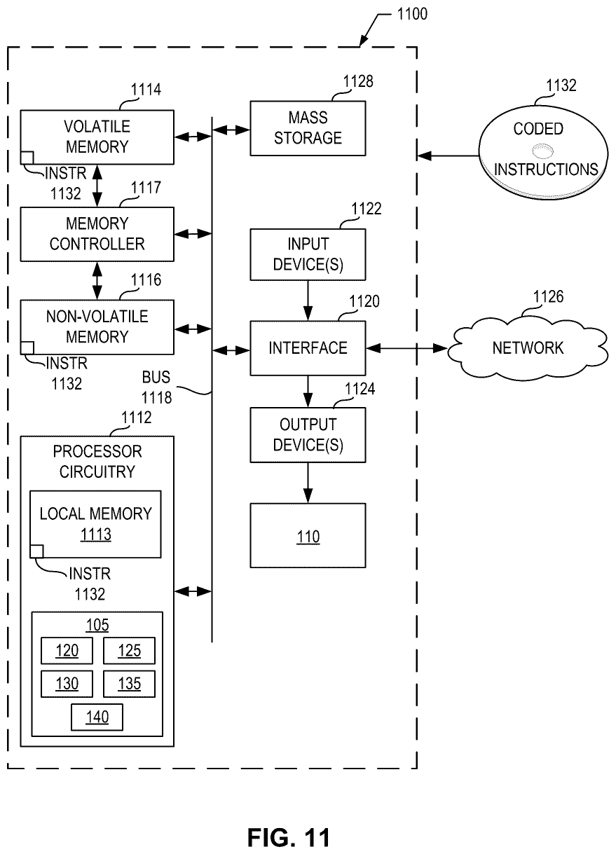

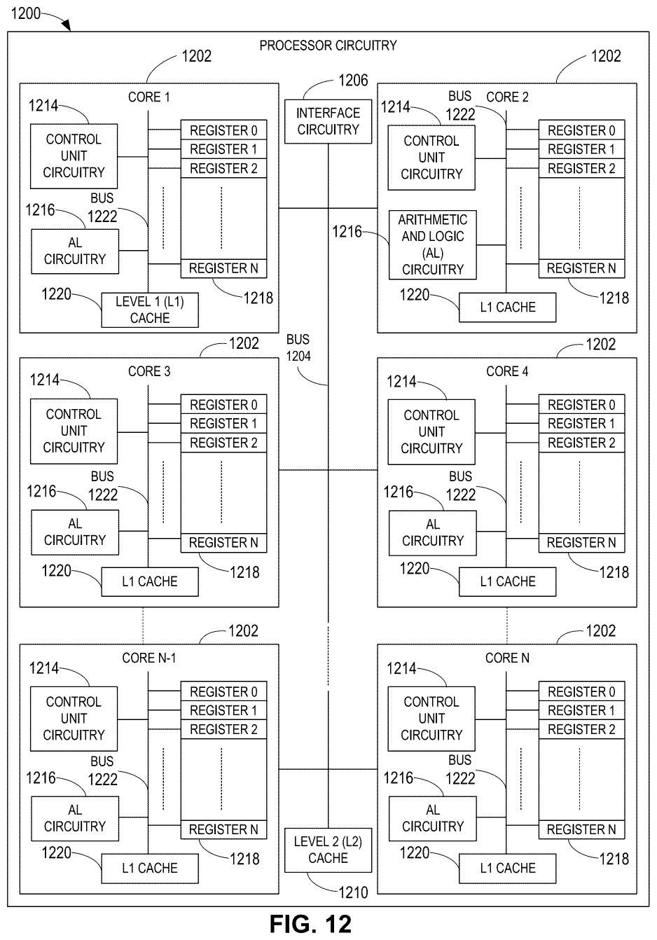

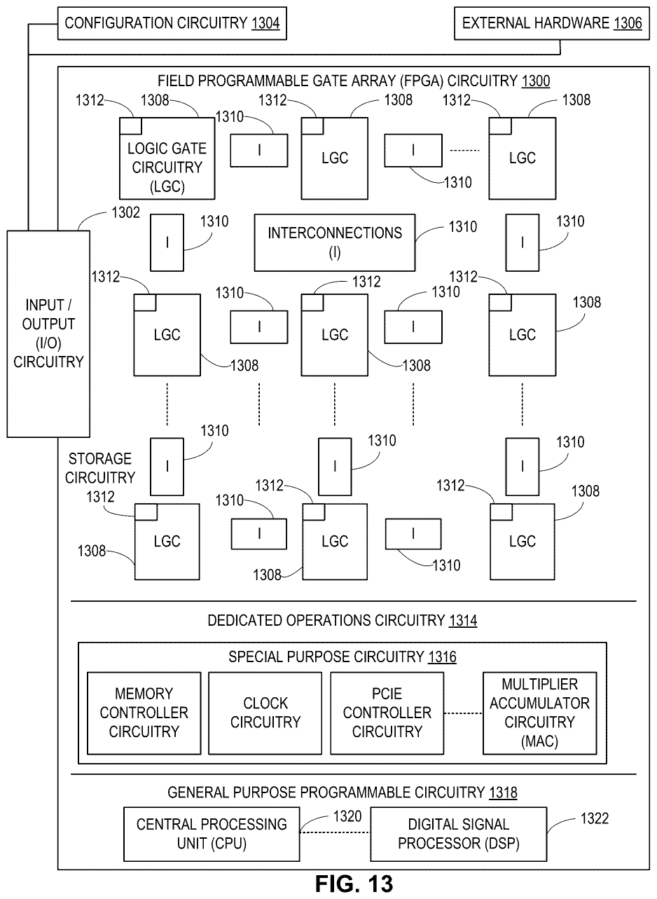

In some examples, the compute device 105 includes means for pixel data scrambling. For example, the means for pixel data scrambling may be implemented by the pixel data scrambler circuitry 120. In some examples, the pixel data scrambler circuitry 120 may be instantiated by programmable circuitry such as the example programmable circuitry 1112 of FIG. 11. For instance, the pixel data scrambler circuitry 120 may be instantiated by the example microprocessor 1200 of FIG. 12 executing machine executable instructions such as those implemented by at least blocks 905-915 of FIG. 9 and/or blocks 1015 and/or 1025 of FIG. 10. In some examples, the pixel data scrambler circuitry 120 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the pixel data scrambler circuitry 120 may be instantiated by any other combination of hardware, software, and/or firmware. For example, the pixel data scrambler circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the compute device 105 includes means for pixel data encrypting. For example, the means for pixel data encrypting may be implemented by the pixel data encryption circuitry 125. In some examples, the pixel data encryption circuitry 125 may be instantiated by programmable circuitry such as the example programmable circuitry 1112 of FIG. 11. For instance, the pixel data encryption circuitry 125 may be instantiated by the example microprocessor 1200 of FIG. 12 executing machine executable instructions such as those implemented by at least block 915 of FIG. 9. In some examples, the pixel data encryption circuitry 125 may be instantiated by hardware logic circuitry, which may be implemented by an ASIC, XPU, or the FPGA circuitry 1300 of FIG. 13 configured and/or structured to perform operations corresponding to the machine-readable instructions.

Additionally or alternatively, the pixel data encryption circuitry 125 may be instantiated by any other combination of hardware, software, and/or firmware. For example, the pixel data encryption circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the pixel data encryption circuitry 125 includes means for controlling. For example, the means for controlling may be implemented by the controller circuitry 805. In some examples, the controller circuitry 805 may be instantiated by programmable circuitry such as the example programmable circuitry 1112 of FIG. 11. For instance, the controller circuitry 805 may be instantiated by the example microprocessor 1200 of FIG. 12 executing machine executable instructions such as those implemented by at least blocks 1005 and/or 1010 of FIG. 10. In some examples, the controller circuitry 805 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the controller circuitry 805 may be instantiated by any other combination of hardware, software, and/or firmware. For example, the controller circuitry 805 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the pixel data encryption circuitry 125 includes means for scrambling bits of pixels. For example, the means for scrambling bits of pixels may be implemented by the pixel bit scrambler circuitry 815. In some examples, the pixel bit scrambler circuitry 815 may be instantiated by programmable circuitry such as the example programmable circuitry 1112 of FIG. 11. For instance, the pixel bit scrambler circuitry 815 may be instantiated by the example microprocessor 1200 of FIG. 12 executing machine executable instructions such as those implemented by at least blocks 1015 and/or 1025 of FIG. 10. In some examples, the pixel bit scrambler circuitry 815 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the pixel bit scrambler circuitry 815 may be instantiated by any other combination of hardware, software, and/or firmware. For example, the pixel bit scrambler circuitry 815 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the pixel data encryption circuitry 125 includes means for reformatting pixels. For example, the means for reformatting pixels may be implemented by the format conversion circuitry 810. In some examples, the format conversion circuitry 810 may be instantiated by programmable circuitry such as the example programmable circuitry 1112 of FIG. 11. For instance, the format conversion circuitry 810 may be instantiated by the example microprocessor 1200 of FIG. 12 executing machine executable instructions such as those implemented by at least block 1020 of FIG. 10. In some examples, the format conversion circuitry 810 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the format conversion circuitry 810 may be instantiated by any other combination of hardware, software, and/or firmware. For example, the format conversion circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While example manners of implementing the compute system 100 is illustrated in FIGS. 1-8, one or more of the elements, processes, and/or devices illustrated in FIGS. 1-8 may be combined, divided, re-arranged, omitted, eliminated, and/or implemented in any other way. Further, the example compute device 105, the example display device 110, the example pixel data scrambler circuitry 120, the example pixel data encryption circuitry 125, the example display engine circuitry 130, the example pixel data decryption circuitry 165, the example link encryption circuitry 175, the example link decryption circuitry 185, the example controller circuitry 805, the example format conversion circuitry 810, the example pixel bit scrambler circuitry 815 and/or, more generally, the example compute system 100 of FIGS. 1-8, may be implemented by hardware alone or by hardware in combination with software and/or firmware. Thus, for example, any of the example compute device 105, the example display device 110, the example pixel data scrambler circuitry 120, the example pixel data encryption circuitry 125, the example display engine circuitry 130, the example pixel data decryption circuitry 165, the example link encryption circuitry 175, the example link decryption circuitry 185, the example controller circuitry 805, the example format conversion circuitry 810, the example pixel bit scrambler circuitry 815, and/or, more generally, the example compute system 100, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example compute system 100 of FIGS. 1-8 may include one or more elements, processes, and/or devices in addition to, or instead of, those illustrated in FIGS. 1-8, and/or may include more than one of any or all of the illustrated elements, processes and devices.

Flowchart(s) representative of example machine-readable instructions, which may be executed by programmable circuitry to implement and/or instantiate the compute device 105 of FIGS. 1-8 and/or representative of example operations which may be performed by programmable circuitry to implement and/or instantiate the compute device 105 of FIGS. 1-8, are shown in FIGS. 9-10. The machine-readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 8-9, many other methods of implementing the example compute device 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 8-9 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement pixel data scrambling in the compute device 105 of FIG. 1. The example machine-readable instructions and/or the example operations 900 of FIG. 9 begin at block 905, at which the pixel data scrambler circuitry 120 of the compute device 105 accesses an original block of pixel data, such as the original block of pixel data 145, to be displayed by a display device, such as the display device 110, as described above. At block 910, the pixel data scrambler circuitry 120 scrambles at least one bit of at least one component of at least one pixel of the original block of pixel data to generate a scrambled block of pixel data, such as the scrambled block of pixel data 150 or the scrambled block of pixel data 725, as described above. At block 915, the pixel data scrambler circuitry 120 invokes the pixel data encryption circuitry 125 of the compute device 105 to cause the cause the scrambled block of pixel data to undergo block encryption by the pixel data encryption circuitry 125 to generate an encrypted block of pixel data, such as the encrypted block of pixel data 160 or the encrypted block of pixel data 735, to be stored and/or processed for transmission to the display device 110, as described above. The example machine-readable instructions and/or the example operations 900 of FIG. 9 then end.

FIG. 10 is a flowchart representative of example machine-readable instructions and/or example operations 910 that may be executed, instantiated, and/or performed by programmable circuitry to implement the processing at block 910 of FIG. 9 and/or the pixel data scrambler circuitry 120 of FIGS. 1 and/or 8. The example machine-readable instructions and/or the example operations 910 of FIG. 10 begin at block 1005 at which the controller circuitry 805 of the pixel data scrambler circuitry 120 accesses alpha component configuration information, such as the alpha configuration data 155, for the original block of pixel data, such as the original block of pixel data 145, as described above. At block 1010, the controller circuitry 805 determines, as described above, whether the alpha component of the original block of pixel data is active. If the alpha component is inactive (corresponding to the “No” output of block 1010), at block 1015 the pixel bit scrambler circuitry 815 of the pixel data scrambler circuitry 120 scrambles one or more LSBs of the alpha component of one or more pixels of the original block of pixel data to generate the scrambled block of pixel data, such as the scrambled block of pixel data 150 or the scrambled block of pixel data 725, as described above. The example machine-readable instructions and/or the example operations 910 of FIG. 10 then end.

However, if the alpha component is active (corresponding to the “Yes” output of block 1010), at block 1020, the format conversion circuitry 810 of the pixel data scrambler circuitry 120 reformats the pixel data to generated a reformatted block of pixel data, such as the reformatted pixel data 715, in which the size of the color components and/or the alpha component of the respective pixels are increased relative to the original pixel block, as described above. At block 1025, the pixel bit scrambler circuitry 815 scrambles one or more LSBs of one or more reformatted color components (and/or one or more LSBs of the reformatted alpha component) of one or more pixels of the reformatted block of pixel data to generate the scrambled block of pixel data, as described above. The example machine-readable instructions and/or the example operations 910 of FIG. 10 then end.

FIG. 11 is a block diagram of an example programmable circuitry platform 1100 structured to execute and/or instantiate the example machine-readable instructions and/or the example operations of FIGS. 8-9 to implement the compute system 100 of FIGS. 1-8. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example pixel data scrambler circuitry 120 (e.g., which may include the example controller circuitry 805, the example format conversion circuitry 810 and/or the example pixel bit scrambler circuitry 815), the example pixel data encryption circuitry 125, the example display engine circuitry 130 (e.g., with the example pixel data decryption circuitry 165 and the example link encryption circuitry 175) and/or, more generally, the example compute device 105.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU. In this example, the output devices 1124 implement the example display device 110 (e.g., with the example link decryption circuitry 185).

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 8-9, may be stored in the mass storage device 1128, in the volatile memory 1114, in the non-volatile memory 1116, and/or on at least one non-transitory computer-readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 8-9 to effectively instantiate the circuitry of FIGS. 1-8 as logic circuits to perform operations corresponding to those machine-readable instructions. In some such examples, the circuitry of FIGS. 1-8 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 8-9.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 8-9 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 8-9. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8-9. As such, the FPGA circuitry 1300 may be configured and/or structured to effectively instantiate some or all of the operations/functions corresponding to the machine-readable instructions of the flowchart(s) of FIGS. 8-9 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 8-9 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 8-9 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 8-9 to perform first operation(s)/function(s), the FPGA circuitry 1300 of FIG. 13 may be configured and/or structured to perform second operation(s)/function(s) corresponding to a second portion of the machine-readable instructions represented by the flowcharts of FIG. 8-9, and/or an ASIC may be configured and/or structured to perform third operation(s)/function(s) corresponding to a third portion of the machine-readable instructions represented by the flowcharts of FIGS. 8-9.

It should be understood that some or all of the circuitry of FIGS. 1-8 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 1-8 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIGS. 1-8 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

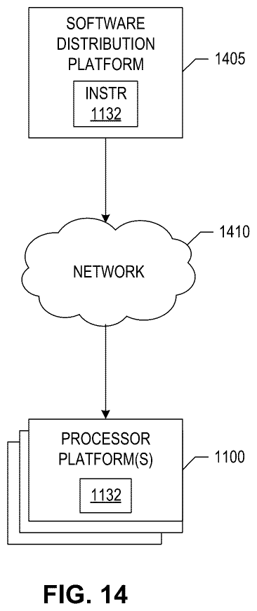

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 8-9, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1132 from the software distribution platform 1405. For example, the software, which may correspond to the example machine-readable instructions of FIG. 8-9, may be downloaded to the example programmable circuitry platform 1100, which is to execute the machine-readable instructions 1132 to implement the compute device 105. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software”could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform scrambling of pixel data prior to video encryption. Disclosed systems, apparatus, articles of manufacture, and methods improve the efficiency of using a computing device by modifying an original block of pixel data, which is to be subsequently encrypted by block-based video encryption (e.g., AES ECB mode encryption). The original block of pixel data may be modified by scrambling, flipping or otherwise modifying one or more bits of one or more components of one or more pixels in the original pixel block to generate a modified block of pixel data, also referred to herein as a scrambled block of pixel data. Such pixel data scrambling reduces or eliminates the reproducibility characteristics that may be present in the encrypted pixel data generated by the block-based video encryption absent such scrambling, thereby reducing or eliminating visible object outlines in the encrypted pixel data. This may avoid leaking confidential information. Disclosed systems, apparatus, articles of manufacture, and methods are accordingly directed to one or more improvement(s), such as security improvement(s) in the operation of a machine such as a computer or other electronic and/or mechanical device, network and/or system.

Further examples and combinations thereof include the following. Example 1 includes an apparatus comprising interface circuitry, machine-readable instructions, and at least one programmable circuit to be programmed based on the machine-readable instructions to access an original block of pixel data to be displayed by a display device, scramble at least one bit of at least one component of at least one pixel of the original block of pixel data to generate a scrambled block of pixel data, and cause the scrambled block of pixel data to undergo block encryption to generate an encrypted block of pixel data.
Example 2 includes the apparatus of example 1, wherein one or more of the at least one programmable circuit is to scramble least significant bits (LSBs) of alpha components of respective pixels in the original block of pixel data to generate the scrambled block of pixel data.
Example 3 includes the apparatus of example 1, wherein one or more of the at least one programmable circuit is to scramble bits of alpha components of respective pixels in the original block of pixel data to generate the scrambled block of pixel data based on a determination that the alpha components are inactive.
Example 4 includes the apparatus of example 3, wherein one or more of the at least one programmable circuit is to determine the alpha components are inactive based on usage of the alpha components.
Example 5 includes the apparatus of example 1, wherein one or more of the at least one programmable circuit is to scramble LSBs of one or more color components of respective pixels in the original block of pixel data to generate the scrambled block of pixel data.
Example 6 includes the apparatus of example 5, wherein the color components include (i) a red component, a green component and a blue component or (ii) a luminance component and chrominance components.
Example 7 includes the apparatus of example 5 or example 6, wherein one or more of the at least one programmable circuit is to scramble the LSBs of the one or more color components of the respective pixels based on a determination that alpha components of the respective pixels are active.
Example 8 includes the apparatus of any one of examples 5 to 7, wherein one or more of the at least one programmable circuit is to reformat the original block of pixel data to increase a number of bits in the one or more color components of the respective pixels prior to scrambling the LSBs of the one or more color components to generate the scrambled block of pixel data.
Example 9 includes the apparatus of example 5, wherein one or more of the at least one programmable circuit is to reformat the original block of pixel data to decrease a number of bits in alpha components of the respective pixels prior to the scrambling of the LSBs of the one or more color components to generate the scrambled block of pixel data.
Example 10 includes the apparatus of example 9, wherein the original block of pixel data is formatted with first color components having a first number of bits, second color components having the first number of bits, third color components having the first number of bits and alpha components having the first number of bits, and the scrambled block of pixel data is formatted with the first color components having a second number of bits, the second color components having the second number of bits, the third color components having the second number of bits and the alpha components having a third number of bits, wherein the second number is larger than the first number, and the third number is smaller than the first number.
Example 11 includes the apparatus of example 5, wherein one or more of the at least one programmable circuit is to reformat the original block of pixel data to increase a number of bits in alpha components of the respective pixels prior to the scrambling of the LSBs of the one or more color components to generate the scrambled block of pixel data.
Example 12 includes the apparatus of example 11, wherein the original block of pixel data is formatted with first color components having 8 bits, second color components having 8 bits, third color components having 8 bits and alpha components having 8 bits, and the scrambled block of pixel data is formatted with the first color components having 16 bits, the second color components having 16 bits, the third color components having 16 bits and the alpha components having 16 bits.
Example 13 includes the apparatus of any one of examples 1 to 12, wherein one or more of the at least one programmable circuit is to at least one of process or cause storage of the encrypted block of pixel data prior to transmission of the pixel data to the display device.
Example 14 includes at least one non-transitory machine-readable storage medium comprising instructions to cause at least programmable circuit of a first compute device to at least access an original block of pixel data to be displayed by a display device, change at least one bit of at least one component of at least one pixel of the original block of pixel data to generate a modified block of pixel data, and cause the modified block of pixel data to undergo block encryption to generate an encrypted block of pixel data.
Example 15 includes the at least one non-transitory machine-readable storage medium of example 14, wherein the instructions are to cause one or more of the at least one programmable circuit to change the at least one bit based on a random number generation algorithm.
Example 16 includes the at least one non-transitory machine-readable storage medium of example 14 or example 15, wherein the instructions are to cause one or more of the at least one programmable circuit to change at least one of multiple least significant bits (LSBs) of alpha components of respective pixels in the original block of pixel data or multiple LSBs of one or more color components of the respective pixels in the original block of pixel data to generate the modified block of pixel data.
Example 17 includes the at least one non-transitory machine-readable storage medium of example 16, wherein the instructions are to cause one or more of the at least one programmable circuit to cause a sequence of original values of the changed LSBs to be sent to the display device.
Example 18 includes the at least one non-transitory machine-readable storage medium of any one of examples 14 to 17, wherein the instructions are to cause one or more of the at least one programmable circuit to at least one of process or cause storage of the encrypted block of pixel data prior to transmission of the pixel data to the display device.
Example 19 includes a system comprising means for scrambling at least one bit of at least one component of at least one pixel of an original block of pixel data to generate a scrambled block of pixel data, and means for encrypting the scrambled block of pixel data to generate an encrypted block of pixel data.
Example 20 includes the system of example 19, wherein the means for scrambling is to scramble the at least one bit based on a random number generation algorithm.
Example 21 includes the system of example 19 or example 20, wherein the means for scrambling is to scramble at least one of least significant bits (LSBs) of alpha components of respective pixels in the original block of pixel data or LSBs of one or more color components of the respective pixels in the original block of pixel data to generate the scrambled block of pixel data.
Example 22 includes the system of example 21, wherein the means for scrambling is to reformat the original block of pixel data to increase a number of bits in the one or more color components of the respective pixels prior to scrambling the at least one of the LSBs of the alpha components or the LSBs of the one or more color components.
Example 23 includes the system of any one of examples 19 to 22, wherein the means for encrypting is to cause storage of the encrypted block of pixel data prior to transmission of the pixel data to the display device.
Example 24 includes a method comprising accessing an original block of pixel data to be displayed by a display device, scrambling at least one bit of at least one component of at least one pixel of the original block of pixel data to generate a scrambled block of pixel data, and encrypting the scrambled block of pixel data to generate an encrypted block of pixel data.
Example 25 includes the method of example 24, wherein the scrambling includes scrambling least significant bits (LSBs) of alpha components of respective pixels in the original block of pixel data to generate the scrambled block of pixel data.
Example 26 includes the method of example 24, wherein the scrambling includes scrambling bits of alpha components of respective pixels in the original block of pixel data to generate the scrambled block of pixel data based on a determination that the alpha components are inactive.
Example 27 includes the method of example 26, including determining the alpha components are inactive based on usage of the alpha components.
Example 28 includes the method of example 24, wherein the scrambling includes scrambling LSBs of one or more color components of respective pixels in the original block of pixel data to generate the scrambled block of pixel data.
Example 29 includes the method of example 28, wherein the color components include (i) a red component, a green component and a blue component or (ii) a luminance component and chrominance components.
Example 30 includes the method of example 28 or example 29, wherein the scrambling includes scrambling the LSBs of the one or more color components of the respective pixels based on a determination that alpha components of the respective pixels are active.
Example 31 includes the method of any one of examples 28 to 30, including reformatting the original block of pixel data to increase a number of bits in the one or more color components of the respective pixels prior to scrambling the LSBs of the one or more color components to generate the scrambled block of pixel data.
Example 32 includes the method of example 28, including reformatting the original block of pixel data to decrease a number of bits in alpha components of the respective pixels prior to the scrambling of the LSBs of the one or more color components to generate the scrambled block of pixel data.
Example 33 includes the method of example 32, wherein the original block of pixel data is formatted with first color components having a first number of bits, second color components having the first number of bits, third color components having the first number of bits and alpha components having the first number of bits, and the scrambled block of pixel data is formatted with the first color components having a second number of bits, the second color components having the second number of bits, the third color components having the second number of bits and the alpha components having a third number of bits, wherein the second number is larger than the first number, and the third number is smaller than the first number.
Example 34 includes the method of example 28, wherein one or more of the at least one programmable circuit is to reformat the original block of pixel data to increase a number of bits in alpha components of the respective pixels prior to the scrambling of the LSBs of the one or more color components to generate the scrambled block of pixel data.
Example 35 includes the method of example 34, wherein the original block of pixel data is formatted with first color components having 8 bits, second color components having 8 bits, third color components having 8 bits and alpha components having 8 bits, and the scrambled block of pixel data is formatted with the first color components having 16 bits, the second color components having 16 bits, the third color components having 16 bits and the alpha components having 16 bits.
Example 36 includes the method of any one of examples 24 to 25, including at least one of processing or storing the encrypted block of pixel data prior to transmission of the pixel data to the display device.
Example 37 includes at least one machine-readable medium comprising machine-readable instructions to cause at least one programmable circuit to perform the method of any one of examples 24 to example 36.
Example 38 includes an apparatus to perform the method of any one of examples 24 to example 36.
Example 39 includes a method performed by any one of the apparatus of examples 1 to example 13.
Example 40 includes at least one machine-readable medium comprising the machine-readable instructions of any one of the apparatus of examples 1 to example 13.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
access an original block of pixel data to be displayed by a display device;
scramble at least one bit of at least one component of at least one pixel of the original block of pixel data to generate a scrambled block of pixel data; and
cause the scrambled block of pixel data to undergo block encryption to generate an encrypted block of pixel data.

2. The apparatus of claim 1, wherein one or more of the at least one programmable circuit is to scramble least significant bits (LSBs) of alpha components of respective pixels in the original block of pixel data to generate the scrambled block of pixel data.

3. The apparatus of claim 1, wherein one or more of the at least one programmable circuit is to scramble bits of alpha components of respective pixels in the original block of pixel data to generate the scrambled block of pixel data based on a determination that the alpha components are inactive.

4. The apparatus of claim 3, wherein one or more of the at least one programmable circuit is to determine the alpha components are inactive based on usage of the alpha components.

5. The apparatus of claim 1, wherein one or more of the at least one programmable circuit is to scramble LSBs of one or more color components of respective pixels in the original block of pixel data to generate the scrambled block of pixel data.

6. The apparatus of claim 5, wherein the color components include (i) a red component, a green component and a blue component or (ii) a luminance component and chrominance components.

7. The apparatus of claim 5, wherein one or more of the at least one programmable circuit is to scramble the LSBs of the one or more color components of the respective pixels based on a determination that alpha components of the respective pixels are active.

8. The apparatus of claim 5, wherein one or more of the at least one programmable circuit is to reformat the original block of pixel data to increase a number of bits in the one or more color components of the respective pixels prior to scrambling the LSBs of the one or more color components to generate the scrambled block of pixel data.

9. The apparatus of claim 5, wherein one or more of the at least one programmable circuit is to reformat the original block of pixel data to decrease a number of bits in alpha components of the respective pixels prior to the scrambling of the LSBs of the one or more color components to generate the scrambled block of pixel data.

10. The apparatus of claim 9, wherein the original block of pixel data is formatted with first color components having a first number of bits, second color components having the first number of bits, third color components having the first number of bits and alpha components having the first number of bits, and the scrambled block of pixel data is formatted with the first color components having a second number of bits, the second color components having the second number of bits, the third color components having the second number of bits and the alpha components having a third number of bits, wherein the second number is larger than the first number, and the third number is smaller than the first number.

11. The apparatus of claim 5, wherein one or more of the at least one programmable circuit is to reformat the original block of pixel data to increase a number of bits in alpha components of the respective pixels prior to the scrambling of the LSBs of the one or more color components to generate the scrambled block of pixel data.

12. The apparatus of claim 11, wherein the original block of pixel data is formatted with first color components having 8 bits, second color components having 8 bits, third color components having 8 bits and alpha components having 8 bits, and the scrambled block of pixel data is formatted with the first color components having 16 bits, the second color components having 16 bits, the third color components having 16 bits and the alpha components having 16 bits.

13. At least one non-transitory machine-readable storage medium comprising instructions to cause at least programmable circuit of a first compute device to at least:
access an original block of pixel data to be displayed by a display device;
change at least one bit of at least one component of at least one pixel of the original block of pixel data to generate a modified block of pixel data; and
cause the modified block of pixel data to undergo block encryption to generate an encrypted block of pixel data.

14. The at least one non-transitory machine-readable storage medium of claim 13, wherein the instructions are to cause one or more of the at least one programmable circuit to change the at least one bit based on a random number generation algorithm.

15. The at least one non-transitory machine-readable storage medium of claim 13, wherein the instructions are to cause one or more of the at least one programmable circuit to change at least one of multiple least significant bits (LSBs) of alpha components of respective pixels in the original block of pixel data or multiple LSBs of one or more color components of the respective pixels in the original block of pixel data to generate the modified block of pixel data.

16. The at least one non-transitory machine-readable storage medium of claim 15, wherein the instructions are to cause one or more of the at least one programmable circuit to cause a sequence of original values of the changed LSBs to be sent to the display device.

17. A system comprising:
means for scrambling at least one bit of at least one component of at least one pixel of an original block of pixel data to generate a scrambled block of pixel data; and
means for encrypting the scrambled block of pixel data to generate an encrypted block of pixel data.

18. The system of claim 17, wherein the means for scrambling is to scramble the at least one bit based on a random number generation algorithm.

19. The system of claim 17, wherein the means for scrambling is to scramble at least one of least significant bits (LSBs) of alpha components of respective pixels in the original block of pixel data or LSBs of one or more color components of the respective pixels in the original block of pixel data to generate the scrambled block of pixel data.

20. The system of claim 19, wherein the means for scrambling is to reformat the original block of pixel data to increase a number of bits in the one or more color components of the respective pixels prior to scrambling the at least one of the LSBs of the alpha components or the LSBs of the one or more color components.
